(19) United States
(12) Patent Application Publication
(10) Pub. No.: US 2020/0101575 A1
(43) Pub. Date: Apr. 2, 2020

(54) SEPARATIVE HIGH-PRESSURE COOLING AND LUBRICATION METHOD FOR ULTRA-HIGH-SPEED CUTTING

(71) Applicant: Beihang University, Beijing (CN)

(72) Inventors: Deyuan Zhang, Beijing (CN); Zhenghui Lu, Beijing (CN); Xiangyu Zhang, Beijing (CN); Zhenlong Peng, Beijing (CN); Ze Gao, Beijing (CN); Xinggang Jiang, Beijing (CN)

(21) Appl. No.: 16/252,981

(22) Filed: Jan. 21, 2019

(30) Foreign Application Priority Data
Sep. 29, 2018 (CN) 201811143954.2

(51) Int. Cl. B23Q 11/10

(52) U.S. Cl. CPC B23Q 11/10

(57) ABSTRACT

A separative high-pressure cooling and lubrication method is provided. The method includes: S1: apply ultrasonic vibration on the cutting tool on a machine tool; S2: deliver high-pressure cutting fluid to a jet nozzle so as to spray the high-pressure cutting fluid to the cutting zone of the ongoing process. The method also includes: S3: set cutting parameters and ultrasonic vibration parameters to adjust the separation amount δ between the cutting tool and workpiece, and adjust the pressure of the high-pressure cutting fluid; S4: when the cutting tool and the workpiece separate completely with each other periodically, the high-pressure cutting fluid enters and flows through the interior of cutting zone, forming liquid film on the surfaces of the cutting tool and the workpiece. In step S4, the cutting tool and the workpiece and cooled, and liquid film is formed on the surfaces of the cutting tool and the workpiece.

### CROSS-REFERENCE TO RELATED APPLICATION

This application claims priority to Chinese application number 201811143954.2, filed on Sep. 29, 2018. The above-mentioned patent application is incorporated herein by reference in its entirety.

### TECHNICAL FIELD

The present invention relates to the field of machining technologies, and in particular, to a cooling and lubrication method for cutting processes.

### BACKGROUND

Cooling and lubrication in a cutting process have a significant influence on the machining capability of cutting tools and the machining quality of workpiece. Cutting is accompanied with intense friction, which causes cutting tools to become blunt and the quality of the working face of the cutting tools to be deteriorated, thus resulting in high energy loss. Using cutting fluid for cooling and lubrication can extend the service life of cutting tools and improve the machining precision as well as surface quality of the workpiece, thereby allowing higher machining efficiency and reducing energy consumption during machining.

High-speed cutting technology is a new technology with high efficiency and quality which implements cutting with a cutting speed much higher than that of ordinary cutting. High-speed cutting can be used for machining conventional materials such as non-ferrous metals, cast iron, and steel. However, it is difficult to implement cutting with high efficiency and quality during cutting of various difficult-to-machine alloy materials such as titanium alloy, superalloy and high-strength steel as well as brittle materials such as resin matrix composite, metal matrix composite and ceramic matrix composite. Different materials have different high-speed ranges. According to the high-speed cutting experiments carried out by the Institute of Production Management, Technology and Machine Tools (PTW) of Darmstadt University of Technology in Germany, speed ranges for high-speed cutting of seven materials including steel, cast iron, nickel base alloy, titanium alloy, aluminum alloy, copper alloy and fiber reinforced plastic are as shown in FIG. 1. Due to intense friction between cutting tools and chips as well as between cutting tools and workpiece during high-speed cutting, cutting heat accumulates quickly, and cutting zone has a very high cutting temperature. Cooling with normal pressure cutting fluid cannot achieve a good cooling and lubrication result, cutting tools wear quickly, and workpiece cannot be lubricated desirably. Application of high-pressure cutting fluid in high-speed cutting field achieves a good cooling and lubrication result. Compared with normal pressure cooling, high-pressure cutting fluid achieves a better cooling and lubrication result, and therefore prolongs the service life of cutting tools and improves the quality of workpiece to some extent.

However, as the pressure inside cutting zone is very high during high-speed and ultra-high-speed cutting, even though the high-pressure cutting fluid is used for cooling, it is still difficult for cutting fluid to enter cutting zone. This makes it hard to further improve the cooling and lubrication effect of cutting processes, and there exist many problems such as short service life of cutting tools and difficulty in improving the machining quality of workpiece.

Therefore, it would be desirable to provide a high-pressure cooling and lubrication method for separative ultra-high-speed cutting, so as to solve the foregoing problems and achieve the goals of reducing cutting heat and prolonging the service life of cutting tools.

### SUMMARY

To achieve the above objectives, the present invention provides the following technical solution, in one embodiment: a separative high-pressure cooling and lubrication method for ultra-high-speed cutting is provided, including the following steps: S1: apply ultrasonic vibration on a cutting tool on a machine tool, so that the ultra-high-speed cutting process becomes an ultra-high-speed discontinuous ultrasonic vibration cutting process; S2: deliver high-pressure cutting fluid to a jet nozzle so as to spray the high-pressure cutting fluid to the cutting zone of the ongoing process; S3: set cutting parameters and ultrasonic vibration parameters to adjust the separation amount δ between the cutting tool and workpiece, and adjust the pressure of the high-pressure cutting fluid; S4: when the cutting tool and the workpiece separate completely with each other periodically at an ultrasonic frequency, the high-pressure cutting fluid enters and flows through the interior of cutting zone, forming liquid film on the surfaces of the cutting tool and the workpiece.

In one aspect, the machine tool in S1 can be a lathe, a milling machine, a drilling machine or a grinding machine; and the cutting tool in S1 can be a lathe tool, a milling cutter, a grinding head, a drilling bit, a reamer or a counter bit.

In another aspect, the ultrasonic vibration in S1 is perpendicular to the direction of cutting speed, or the ultrasonic vibration has a vibration component perpendicular to the direction of cutting speed, so that the cutting tool can periodically separate from the workpiece.

In a further aspect, the ultrasonic vibration in S1 can be axial ultrasonic vibration, radial ultrasonic vibration or elliptical ultrasonic vibration.

In yet another aspect, the high-pressure cutting fluid in S2 can be oil-based cutting fluid, oil-based cutting mist, water-based cutting fluid, water-based cutting mist or liquid nitrogen.

In one aspect, the jet nozzle in S2 is located outside or inside the cutting tool.

In some embodiments, the high-pressure cutting fluid in S2 is sprayed to the cutting zone from a rake surface of the cutting tool, from a flank surface of the cutting tool, or from both the rake surface and the flank surface of the cutting tool.

In another aspect, as the separation amount δ in S3 increases, a better cooling and lubrication effect is achieved; and the optimal setting strategy for cutting parameters and vibration parameters is as follows: the separation amount δ should be maximized, that is, a relatively small offset Δ between center lines of two adjacent cutting trajectories of the cutting tool should be taken, a relatively large amplitude A should be taken, and a phase difference φ between two adjacent cutting trajectories of the cutting tool around 180° is taken.

In a further aspect, when the separation amount δ in S3 is relatively small or cutting speed is relatively high, the pressure of the high-pressure cutting fluid should be set to be relatively high; and when the separation amount δ in S3 is relatively large or the cutting speed is relatively low, the pressure of the high-pressure cutting fluid can be set to be relatively low.

In one aspect, in S3, the cutting parameters include cutting speed, depth of cut and feed rate of the cutting tool, and the vibration parameters include vibration frequency and amplitude; the vibration frequency range here is 16-60 kHz, and vibration amplitude range is 2-50 um; in S3, the offset range is 1-50 um, and the phase difference range is 30°-330°; and the pressure range of cutting fluid in S3 is 50-1000 bar.

Compared with conventional designs, the present invention achieves the following technical effects. In the present invention, when cutting tool and workpiece separate completely with each other periodically at an ultrasonic frequency, high-pressure cutting fluid enters and flows through the interior of cutting zone, to lower cutting temperature carrying away heat from cutting tool and workpiece, and to form liquid film on the surfaces of cutting tool and workpiece, thus achieving lubrication and friction reduction for the cutting process. The present invention can significantly lower cutting temperature during high-speed cutting of aerospace materials that are difficult to machine, greatly prolong the service life of cutting tools, and thus improve machining efficiency and quality.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrate one or more embodiments of the invention and, together with the general description given above and the detailed description given below, explain the one or more embodiments of the invention.

FIG. 1 is a bar graph shows speed ranges of high-speed cutting for different materials.

FIG. 2 is a schematic side view diagram of a separative high-pressure cooling and lubrication method for ultra-high-speed cutting according to one embodiment of the present invention.

FIG. 3 is a schematic side view diagram of forming lubricating liquid film according to embodiments of the present invention.

FIG. 4 is a schematic side view diagram of feeding cutting fluid from a rake surface according to one embodiment of the present invention.

FIG. 5 is a schematic side view diagram of feeding cutting fluid from a flank surface according to another embodiment of the present invention.

FIG. 6 is a schematic side view diagram of feeding cutting fluid from both a rake surface and flank surface according to yet another embodiment of the present invention.

FIG. 7 is a schematic perspective view diagram of turning using the separative high-pressure cooling and lubrication method of one embodiment of the invention.

FIG. 8 is a schematic perspective view diagram of milling using the separative high-pressure cooling and lubrication method of one embodiment of the invention.

FIG. 9 is another schematic perspective view diagram of milling using the separative high-pressure cooling and lubrication method.

FIG. 10 is a schematic perspective view diagram of grinding using the separative high-pressure cooling and lubrication method of another embodiment of the invention.

FIG. 11 is another schematic perspective view diagram of grinding using the separative high-pressure cooling and lubrication method.

FIG. 12 is a schematic perspective partially-sectioned view of drilling using the separative high-pressure cooling and lubrication method of one embodiment of the invention.

FIG. 13 is a schematic perspective partially-sectioned view of reaming using the separative high-pressure cooling and lubrication method of yet another embodiment of the invention.

FIG. 14 is a schematic perspective partially-sectioned view of counter boring using the separative high-pressure cooling and lubrication method of one embodiment of the invention.

FIG. 15 is a graph plotting and comparing the cutting temperature of the separative high-pressure cooling and lubrication method of the present invention and the cutting temperature of conventional high-pressure cooling methods for ultra-high-speed cutting.

FIG. 16 is a graph plotting and comparing cutting tool wear of the separative high-pressure cooling and lubrication method of the present invention and cutting tool wear of conventional high-pressure cooling method for ultra-high-speed cutting.

FIG. 17 is a graph plotting and comparing the cutting distance of the separative high-pressure cooling and lubrication method of the present invention and the cutting distance of conventional high-pressure cooling method for ultra-high-speed cutting.

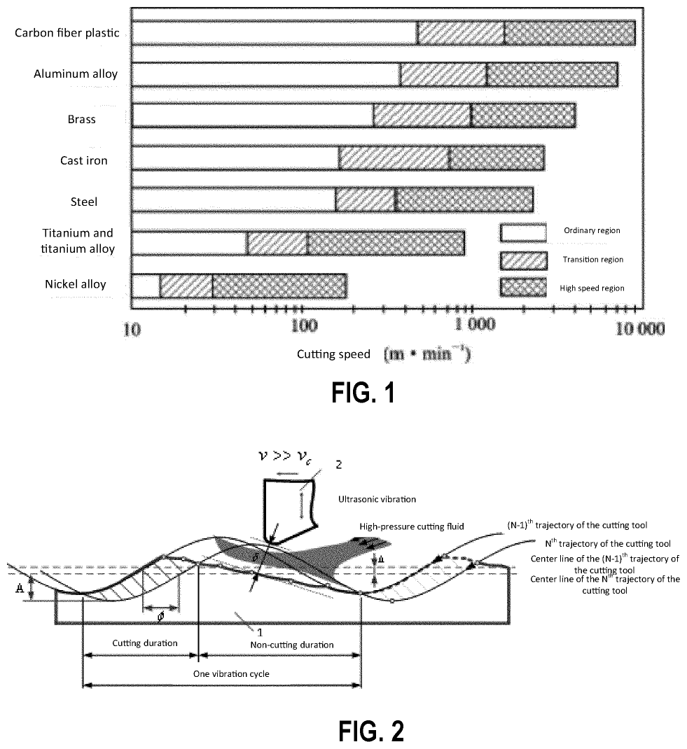

### DETAILED DESCRIPTION

The following clearly and completely describes the technical solutions in the embodiments of the present invention with reference to the accompanying drawings in the embodiments of the present invention. To make objectives, features, and advantages of the present invention clearer, the following describes embodiments of the present invention in more detail with reference to accompanying drawings and specific implementations.

An objective of the present invention is to provide a separative high-pressure cooling and lubrication method for ultra-high-speed cutting, to thereby reduce cutting heat, prolong the service life of cutting tools, and improve the machining efficiency and quality.

To make the foregoing objective, features, and advantages of the present invention clearer and more comprehensible, the present invention is further described in detail below with reference to the accompanying drawings and specific embodiments.

### Embodiment 1

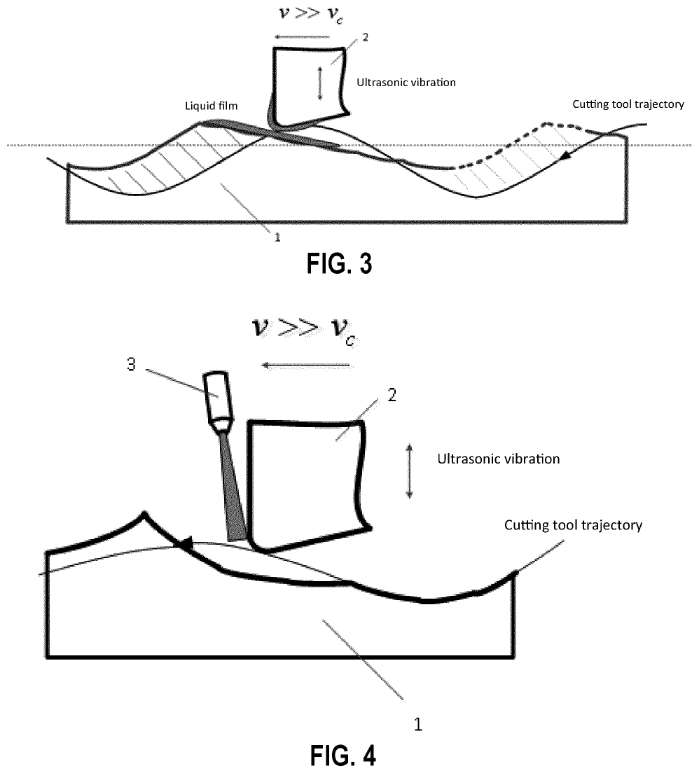

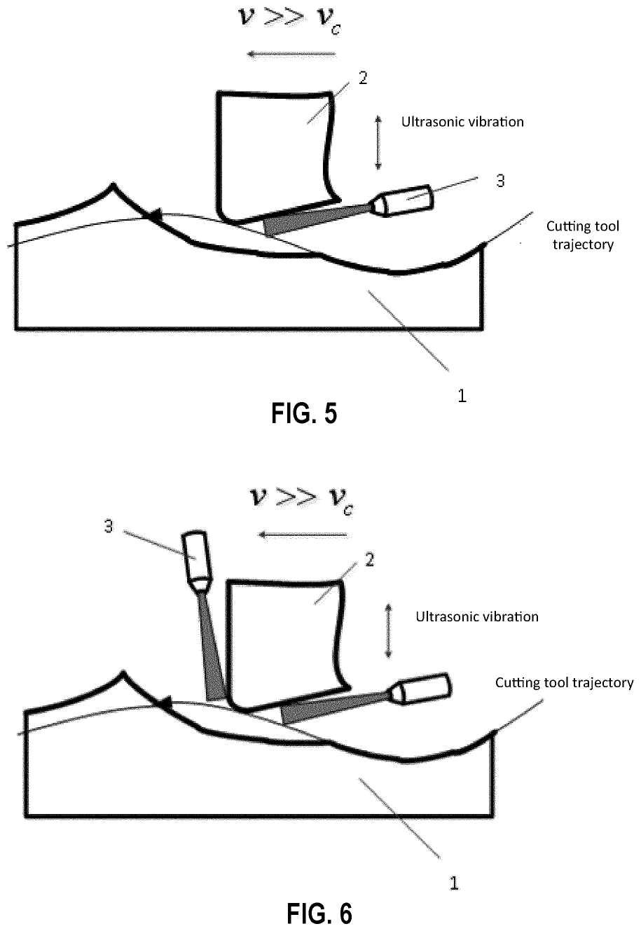

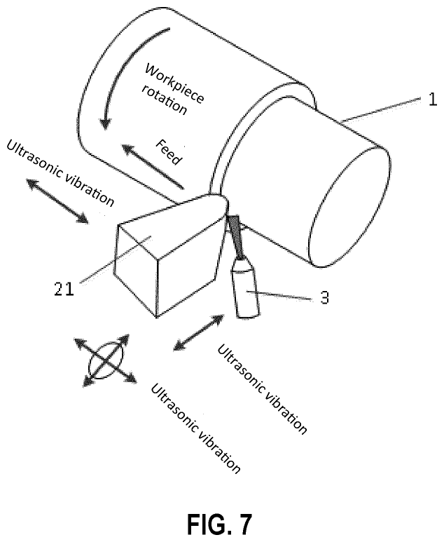

As shown in FIG. 2 through FIG. 7, in this embodiment, the separative high-pressure cooling and lubrication method for ultra-high-speed cutting is applied to the process of turning titanium alloy. The method includes the following steps:
S1: Clamp a workpiece 1 on the spindle of a lathe, and start the machine tool to carry out ultra-high-speed discontinuous ultrasonic vibration turning; when ultrasonic vibration of the cutting tool 2 is along the axial direction, the vibration direction of the lathe tool 21 is perpendicular to cutting speed direction and parallel to the feed direction of the lathe tool 21; when ultrasonic vibration of the lathe tool 21 is along the radial direction, the vibration direction of the lathe tool 21 is perpendicular to the cutting speed direction and points to the center line of the workpiece 1; when the vibration direction is along an ellipse locus, the vibration direction of the lathe tool 21 is a synthesis of directions of axial ultrasonic vibration and radial ultrasonic vibration, and the vibration plane of the lathe tool 21 is perpendicular to the cutting speed direction.
S2: Start supplying high-pressure cutting fluid, where the high-pressure cutting fluid can be sprayed from a jet nozzle 3 inside or outside the toolbar of the lathe tool 21 to its rake surface or flank surface, or to both the rake surface and the flank surface.
S3: Adjust turning parameters (the lathe tool 21 has a linear cutting speed of 400 m/min, a cutting depth of 0.05 mm and a feed rate of 0.005 mm/r) and vibration parameters of the lathe tool 21 (its vibration frequency is 22330 Hz and vibration amplitude is 8 um), where the phase difference is 180°; then adjust the pressure of the cutting fluid to be 200 bar.
S4: When the lathe tool 21 and the workpiece 1 are completely separated with each other periodically at an ultrasonic frequency, the high-pressure cutting fluid enters and flows through the interior of the cutting zone and forms liquid film on the surfaces of the lathe tool 21 and the workpiece 1, thus achieving separative high-pressure cooling and lubrication for ultra-high-speed turning.

### Embodiment 2

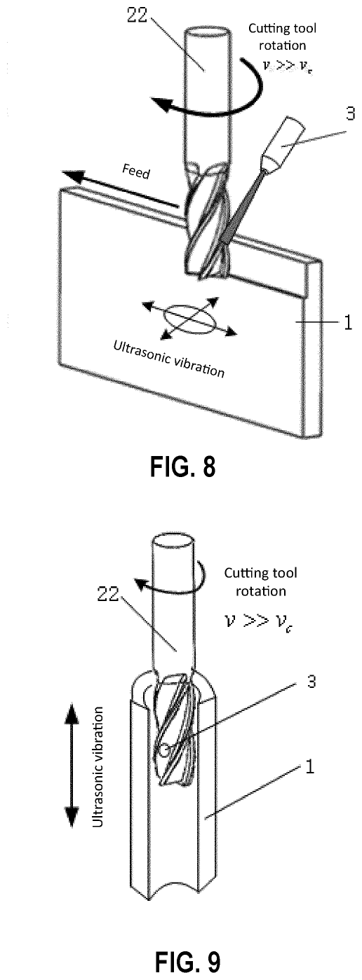

As shown in FIG. 8 and FIG. 9, in this embodiment, the separative high-pressure cooling and lubrication method for ultra-high-speed cutting is applied to the process of milling titanium alloy. The method includes the following steps:
S1: Fix a workpiece 1 on a milling machine, and start the machine tool to carry out ultra-high-speed discontinuous ultrasonic vibration milling; when the side edge of the milling cutter 22 is used to mill the side surface of the workpiece 1, ultrasonic vibration of the cutting tool 2 is along an ellipse locus, and the elliptical ultrasonic vibration has a vibration component perpendicular to the cutting speed direction of each teeth of the milling cutter 22; and when the milling cutter 22 is a plunge mill cutter and used to mill a rounded corner, ultrasonic vibration of the cutting tool 2 is along an axial direction, and the axial ultrasonic vibration is perpendicular to the cutting speed direction of each teeth of the milling cutter 22.
S2: Start supplying high-pressure cutting fluid, and when the side edge of the milling cutter 22 is used to mill the side surface of the workpiece 1, the high-pressure cutting fluid can be sprayed from a jet nozzle 3 inside or outside the milling cutter 22 to the cutting zone; and when the milling cutter 22 is used to mill a rounded corner, the high-pressure cutting fluid is supplied from the interior of the milling cutter 22 and sprayed to the cutting zone.
S3: Adjust milling parameters (the milling cutter 22 has a linear cutting speed of 450 m/min, a radial cutting depth of 0.1 mm, an axial cutting depth of 8 mm and a feed rate of 0.01 mm/r) and vibration parameters of the milling cutter 22 (the vibration frequency is 28500 Hz and the vibration amplitude is 8 um), where the phase difference is 180°; and adjust the pressure of the cutting fluid to be 250 bar.
S4: When the milling cutter 22 and the workpiece 1 are completely separated with each other periodically at an ultrasonic frequency, the high-pressure cutting fluid enters and flows through the interior of the cutting zone and forms liquid film on the surfaces of the milling cutter 22 and the workpiece 1, thus achieving separative high-pressure cooling and lubrication for ultra-high-speed milling.

### Embodiment 3

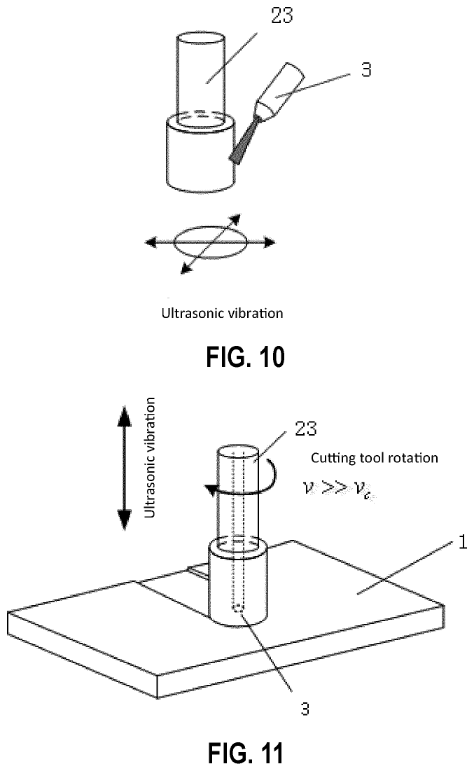

As shown in FIG. 10 and FIG. 11, in this embodiment, the separative high-pressure cooling and lubrication method for ultra-high-speed cutting is applied to the process of grinding titanium alloy. The method includes the following steps:
S1: Fix a workpiece 1 on a grinding machine, and start the machine tool to carry out ultra-high-speed discontinuous ultrasonic vibration grinding; when the grinding head 23 is used to grind the side surface of the workpiece 1, ultrasonic vibration of the grinding head 23 is along an ellipse locus, and the elliptical ultrasonic vibration has a vibration component perpendicular to the cutting speed direction of each grain of the grinding head 23; and when the grinding head 23 is used to grind the end surface of the workpiece 1, ultrasonic vibration of the grinding head 23 is along the axial direction, and the axial ultrasonic vibration is perpendicular to the cutting speed direction of each grain of the grinding head 23.
S2: Start supplying high-pressure cutting fluid; when the grinding head 23 is used to grind the side surface of the workpiece 1, the high-pressure cutting fluid can be sprayed from a jet nozzle 3 inside or outside the grinding head 23 to the cutting zone; and when the grinding head 23 is used to grind the end surface of the workpiece 1, the high-pressure cooling liquid is supplied from the interior of the grinding head 23 and sprayed to the cutting zone.
S3: Adjust grinding parameters (the cutting tool 2 has a maximum linear cutting speed of 50 m/s, an axial cutting depth of 0.5 mm, a radial cutting depth of 0.01 mm and a feed rate of 600 mm/min) and vibration parameters of the grinding cutter (the vibration frequency is 22800 Hz and the vibration amplitude is 8 um), where the phase difference is 180°; and adjust the pressure of the cutting fluid to be 500 bar.
S4: When the grinding head 23 and the workpiece 1 are completely separated with each other periodically at an ultrasonic frequency, the high-pressure cutting fluid enters and flows through the interior of the cutting zone and forms liquid film on the surfaces of the grinding head 23 and the workpiece 1, thus achieving separative high-pressure cooling and lubrication for ultra-high-speed grinding.

### Embodiment 4

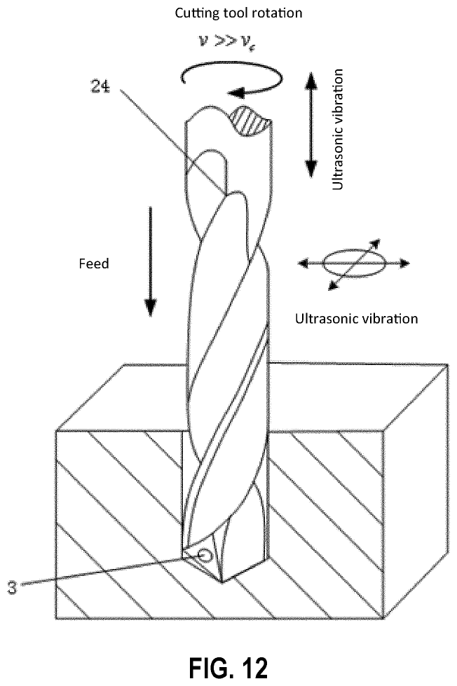

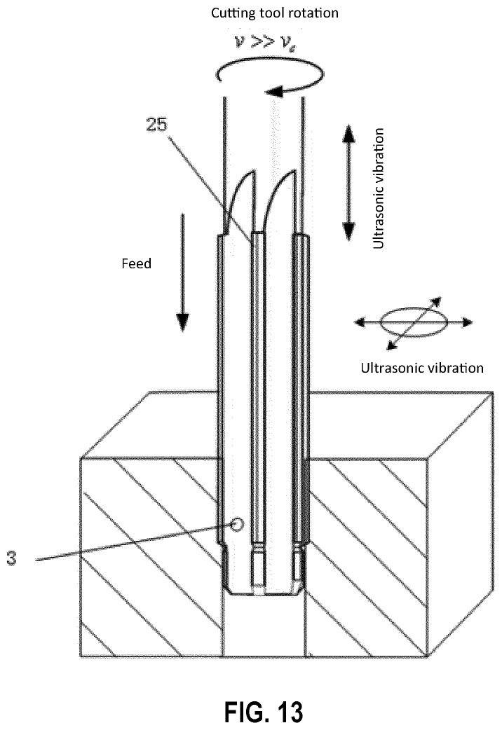

As shown in FIG. 12, in this embodiment, the separative high-pressure cooling and lubrication method for ultra-high-speed cutting is applied to the process of drilling titanium alloy. The method includes the following steps:
S1: Fix a workpiece 1 on a drilling machine, and start the machine tool to carry out ultra-high-speed discontinuous ultrasonic vibration drilling; when ultrasonic vibration of the drilling bit 24 is along an axial direction, the vibration direction of the drilling bit 24 is perpendicular to the cutting speed direction and parallel to the feed direction of the drilling bit 24; and when ultrasonic vibration of the drilling bit 24 is along an ellipse locus, the elliptical ultrasonic vibration of the drilling bit 24 has a vibration component perpendicular to the cutting speed direction of the cutting edges of the drilling bit 24.
S2: Start supplying high-pressure cutting fluid, where the high-pressure cutting fluid is supplied from the interior of the drilling bit 24 and sprayed to the cutting zone.
S3: Adjust drilling parameters (the cutting tool 2 has a linear cutting speed of 200 m/min and a feed rate of 0.01 mm/r) and vibration parameters of the drilling bit 24 (the vibration frequency is 27089 Hz and the vibration amplitude is 10 um), where the phase difference is 180°; and adjust the pressure of the cutting fluid to be 400 bar.
S4: When the drilling bit 24 and the workpiece 1 are completely separated with each other periodically at an ultrasonic frequency, the high-pressure cutting fluid enters and flows through the interior of the cutting zone and forms liquid film on the surfaces of the drilling bit 24 and the workpiece 1, thus achieving separative high-pressure cooling and lubrication for ultra-high-speed drilling.

### Embodiment 5

As shown in FIG. 13, in this embodiment, the separative high-pressure cooling and lubrication method for ultra-high-speed cutting is applied to the process of reaming titanium alloy. The method includes the following steps:
S1: Fix a workpiece 1 on a reaming machine, and start the machine tool to carry out ultra-high-speed discontinuous ultrasonic vibration reaming; when ultrasonic vibration of the reamer 25 is along an axial direction, the vibration direction of the reamer 25 is perpendicular to the cutting speed direction and parallel to the feed direction of the reamer 25; and when ultrasonic vibration of the reamer 25 is along an ellipse locus, the elliptical ultrasonic vibration of the reamer 25 has a vibration component perpendicular to the cutting speed direction of the cutting edges of the reamer 25.
S2: Start supplying high-pressure cutting fluid, where the high-pressure cutting fluid is supplied from the interior of the reamer 25 and sprayed to the cutting zone.
S3: Adjust reaming parameters (the cutting tool 2 has a linear cutting speed of 200 m/min, a cutting depth of 0.10 mm and a feed rate of 0.005 mm/r) and vibration parameters of the reamer 25 (the vibration frequency is 21350 Hz and the vibration amplitude is 3 um), where the phase difference is 180°; and adjust the pressure of the cutting fluid to be 200 bar.
S4: When the reamer 25 and the workpiece 1 are completely separated with each other periodically at an ultrasonic frequency, the high-pressure cutting fluid enters and flows through the interior of the cutting zone and forms liquid film on the surfaces of the reamer 25 and the workpiece 1, thus achieving separative high-pressure cooling and lubrication for ultra-high-speed reaming.

### Embodiment 6

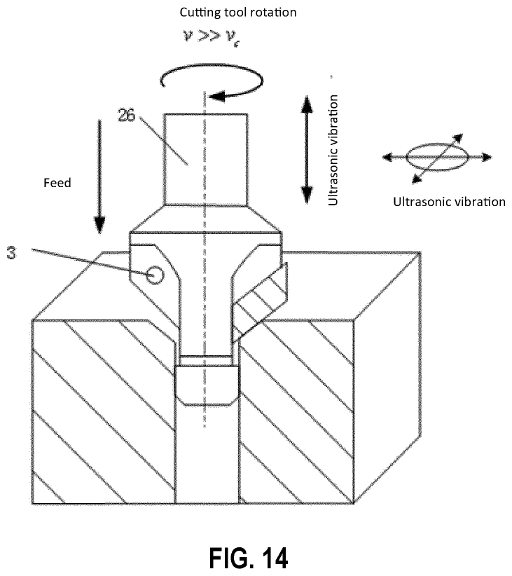

As shown in FIG. 14, in this embodiment, the separative high-pressure cooling and lubrication method for ultra-high-speed cutting is applied to the process of counter boring titanium alloy. The method includes the following steps:
S1: Fix a workpiece 1 on a counter boring machine, and start the machine tool to carry out ultra-high-speed discontinuous ultrasonic vibration counter boring; when ultrasonic vibration of the counter bit 26 is along an axial direction, the vibration direction of the counter bit 26 is perpendicular to the cutting speed direction and parallel to the feed direction of the counter bit 26; and when ultrasonic vibration of the counter bit 26 is along an ellipse locus, the elliptical ultrasonic vibration of the counter bit 26 has a vibration component perpendicular to the cutting speed direction of the cutting edges of the counter bit 26.
S2: Start supplying high-pressure cutting fluid, where the high-pressure cutting fluid is supplied from the interior of the counter bit 26 and sprayed to the cutting zone.
S3: Adjust counter boring parameters (the cutting tool 2 has a linear cutting speed of 400 m/min and a feed rate of 0.005 mm/r) and vibration parameters of the counter bit 26 (the vibration frequency is 28500 Hz and the vibration amplitude is 8 um), where the phase difference is 180°; and adjust the pressure of the cutting fluid to be 200 bar.
S4: When the counter bit 26 and the workpiece 1 are completely separated with each other periodically at an ultrasonic frequency, the high-pressure cutting fluid enters and flows through the interior of the cutting zone and forms liquid film on the surfaces of the counter bit 26 and the workpiece 1, thus achieving separative high-pressure cooling and lubrication for ultra-high-speed counter boring.

The magnitude of the separation amount depends on the cutting parameters and the vibration parameters. As the separation amount δ increases, a better cooling and lubrication effect is achieved. An optimal setting strategy for the cutting parameters and the vibration parameters is as follows: the separation amount should be maximized, that is, a relatively small offset Δ between center lines of two adjacent cutting trajectories of the cutting tool is taken, a relatively large amplitude A is taken, and a phase difference φ between two adjacent cutting trajectories of the cutting tool that form an angle close to 180° is taken.

When the separation amount δ is relatively small or a cutting speed is relatively high, the pressure of the high-pressure cutting fluid is set to be relatively high; and when the separation amount δ is relatively large or the cutting speed is relatively low, the pressure of the high-pressure cutting fluid set to be relatively low.

The value of the separation amount depends on the machining process and the cutting parameters. The cutting parameters are given according to different machining materials and machining processes.

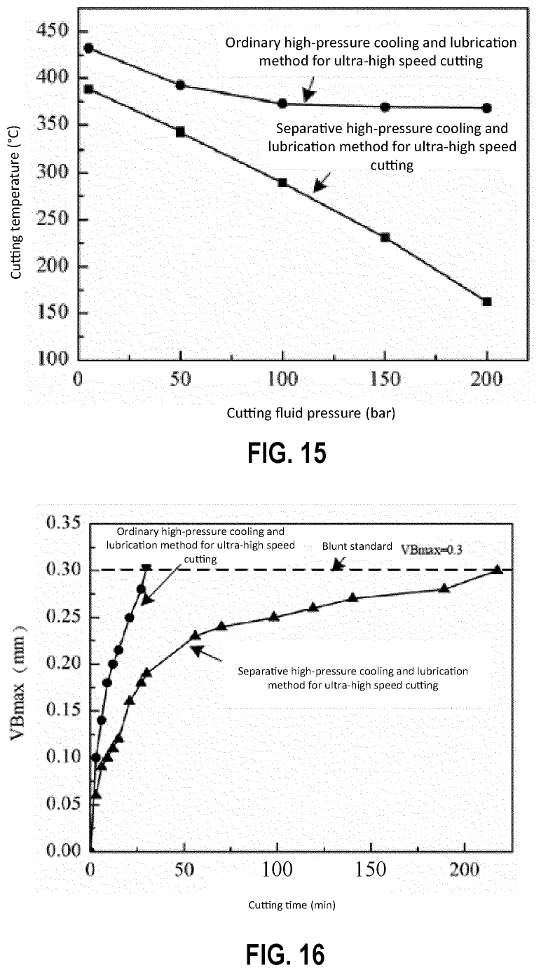

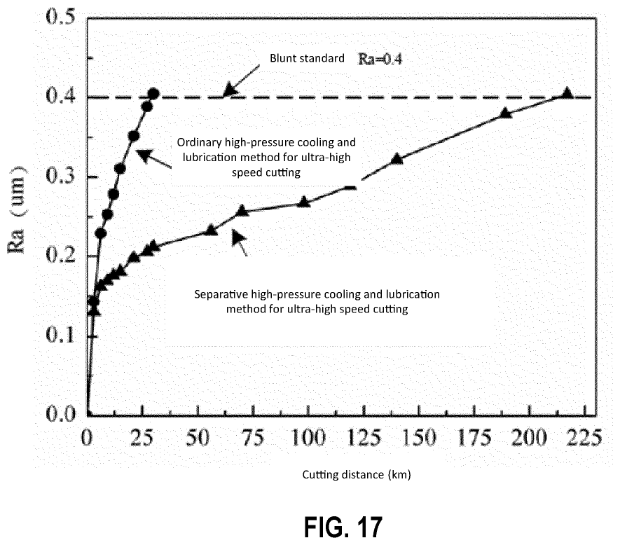

In ultra-high-speed cutting machining, by taking advantage of the discontinuous separation effect between the cutting tool 2 and the workpiece 1 during ultrasonic vibration, the high-pressure cutting fluid is sprayed from a particular position to the cutting tool 2, so that sufficient amount of cutting fluid can completely enter the cutting zone to cool and lubricate the cutting tool 2 and the workpiece 1 sufficiently, thereby significantly improving the machining efficiency and the machining quality in the case of keeping the consumption of the cutting tool 2 unchanged. FIG. 15 through FIG. 17 show high-pressure cooling tests for ultra-high-speed turning of titanium alloy, where the cutting parameters include a linear cutting speed of 400 m/min, a cutting depth of 0.05 mm and a feed rate of 0.005 mm/r, and the cutting fluid is emulsified liquid. It can be seen from FIG. 15 that compared with ordinary high-pressure cooling method for ultra-high-speed cutting, the separative high-pressure cooling and lubrication method for ultra-high-speed cutting in the present invention can greatly lower the cutting temperature. It can be seen from FIG. 16 that when the blunt standard is set as VB=0.3, compared with the ordinary high-pressure cooling method for ultra-high-speed cutting, the separative high-pressure cooling and lubrication method for ultra-high-speed cutting in the present invention increases the service life of the cutting tool 2 by 6 times. The present invention can significantly delay wear of the cutting tool 2 and prolong the service life of the cutting tool 2. It can be seen from FIG. 17 that with Ra=0.4 as a failure standard for precision cutting, under the same cutting speed condition, the separative high-pressure cooling and lubrication method for ultra-high-speed cutting in the present invention can increase the cutting distance of the cutting tool 2 by 6 times compared with the ordinary high-pressure cooling method for ultra-high-speed cutting. Therefore, the present invention can significantly improve the cutting distance of the cutting tool 2.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the invention.

The embodiments described above are only descriptions of preferred embodiments of the present invention and are not intended to limit the scope of the present invention. Various variations and modifications can be made to the technical solution of the present invention by those of ordinary skill in the art, without departing from the design and spirit of the present invention. The variations and modifications should all fall within the claimed scope defined by the claims of the present invention.

What is claimed is:

1. A separative high-pressure cooling and lubrication method for ultra-high-speed cutting, comprising:
S1: apply ultrasonic vibration on a cutting tool on a machine tool, so that an ultra-high-speed cutting process becomes an ultra-high-speed discontinuous ultrasonic vibration cutting process;
S2: deliver high-pressure cutting fluid to a jet nozzle to spray the high-pressure cutting fluid to a cutting zone of the cutting process;
S3: set cutting parameters and ultrasonic vibration parameters to adjust a separation amount δ between the cutting tool and workpiece, and adjust a pressure of the high-pressure cutting fluid; and
S4: when the cutting tool and the workpiece separate completely with each other periodically at an ultrasonic frequency, the high-pressure cutting fluid enters and flows through the interior of cutting zone, forming liquid film on surfaces of the cutting tool and the workpiece.

2. The cooling and lubrication method of claim 1, wherein the machine tool in step S1 can be a lathe, a milling machine, a drilling machine or a grinding machine; and the cutting tool in step S1 can be a lathe tool, a milling cutter, a grinding head, a drilling bit, a reamer or a counter bit.

3. The cooling and lubrication method of claim 1, wherein the ultrasonic vibration in step S1 is perpendicular to a direction of cutting speed, or the ultrasonic vibration has a vibration component perpendicular to the direction of cutting speed, so that the cutting tool can periodically separate from the workpiece.

4. The cooling and lubrication method of claim 3, wherein the ultrasonic vibration in step S1 can be axial ultrasonic vibration, radial ultrasonic vibration or elliptical ultrasonic vibration.

5. The cooling and lubrication method of claim 1, wherein the high-pressure cutting fluid in step S2 can be oil-based cutting fluid, oil-based cutting mist, water-based cutting fluid, water-based cutting mist or liquid nitrogen.

6. The cooling and lubrication method of claim 1, wherein the jet nozzle in step S2 is located outside or inside the cutting tool.

7. The cooling and lubrication method of claim 1, wherein the high-pressure cutting fluid in step S2 is sprayed to cutting zone from rake surface of the cutting tool, from flank surface of the cutting tool, or from both the rake surface and the flank surface of the cutting tool.

8. The cooling and lubrication method of claim 1, wherein as the separation amount δ in step S3 increases, a better cooling and lubrication effect is achieved; and an optimal setting strategy for cutting parameters and vibration parameters is as follows: the separation amount δ should be maximized, that is, a relatively small offset Δ between center lines of two adjacent cutting trajectories of the cutting tool should be taken, a relatively large amplitude A should be taken, and a phase difference φ between two adjacent cutting trajectories of the cutting tool around 180° is taken.

9. The cooling and lubrication method of claim 8, wherein in step S3, the cutting parameters comprise cutting speed, depth of cut and feed rate of the cutting tool, and the vibration parameters comprise vibration frequency and amplitude; a vibration frequency range is 16-60 kHz, and vibration amplitude range is 2-50 um; in step S3, an offset range is 1-50 um, and a phase difference range is 30°-330°; and a pressure range of cutting fluid in S3 is 50-1000 bar.

10. The cooling and lubrication method of claim 1, wherein when the separation amount δ in step S3 is relatively small or cutting speed is relatively high, the pressure of the high-pressure cutting fluid should be set to be relatively high; and when the separation amount δ in step S3 is relatively large or the cutting speed is relatively low, the pressure of the high-pressure cutting fluid can be set to be relatively low.
